(19) United States
(12) Patent Application Publication
(10) Pub. No.: US 2014/0077970 A1
(43) Pub. Date: Mar. 20, 2014

(54) METHOD FOR PARALLEL METER-READING BETWEEN CONCENTRATOR AND ELECTRICITY METERS

(71) Applicant: LSIS CO., LTD., Anyang-si (KR)

(72) Inventor: Young Gyu YU, Seoul (KR)

(73) Assignee: LSIS CO., LTD., Anyang-si (KR)

(21) Appl. No.: 14/021,848

(22) Filed: Sep. 9, 2013

(30) Foreign Application Priority Data
Sep. 14, 2012 (KR) 10-2012-0102072

(51) Int. Cl. G01D 4/00

(52) U.S. Cl. CPC G01D 4/002
USPC 340/870.03

(57) ABSTRACT

A parallel meter-reading method between a concentrator and electricity meters includes determining a phase of electric power supplied from a concentrator to the electricity meters, generating a reference signal synchronized with electric power determined for each phase, generating a request signal synchronized with the 3 phases electric power determined and transmitting the generated request signal to an electricity meter modem, receiving the request signal, determining a phase of electric power supplied to the electricity meter according to the request signal, generating a response signal synchronized with the determined phase and transmitting the generated response signal to the concentrator modem, and receiving the response signal of the electricity meter modem with respect to the request signal, and determining whether or not the response signal is synchronized with the reference signal to determine the phase of electric power supplied to the electricity meter.

### CROSS-REFERENCE TO RELATED APPLICATION

Pursuant to 35 U.S.C. §119(a), this application claims the benefit of earlier filing date and right of priority to Korean Application No. 10-2012-0102072, filed on Sep. 14, 2012, the contents of which is incorporated by reference herein in its entirety.

### BACKGROUND OF THE DISCLOSURE

1. Field of the Disclosure

This disclosure relates to parallel meter reading (metering) between a concentrator and electricity meters, and particularly, to parallel meter reading between the concentrator and electricity meters capable of avoiding a hidden node collision.

2. Background of the Disclosure

Power line communication has advantages of low investment costs in view of using existing power lines without installation of another communication line, and simplified communication by connecting a plug into a socket installed on a wall. Therefore, the power line communication is considered as the most appropriate medium in various types of fields, such as home networking, home automation, remote metering, and factory automation.

In general, a remote meter-reading (remote metering) for an electricity meter (in other words an watt-hour meter) using power line communication allows a concentrator, which is installed on a secondary winding in a pole transformer, to read data of electricity meters of every consumer connected to the secondary winding of the pole transformer.

FIG. 1 is a configuration view of a typical meter-reading method between a concentrator and electricity meters according to the related art.

A concentrator 20 may include a meter-reading processor 22 for reading data of electricity meters 10-1, 10-2, . . . , 10-N, and a concentrator modem 21 for power line communication. Each meter 10-1, 10-2, . . . , 10-N for executing power line communication with the concentrator 20 may include a metering/communication unit 11-1, 11-2, . . . , 11-N, and an electricity meter modem 12-1, 12-2, . . . , 12-N.

The meter-reading processor 22 and the concentrator modem 21 of the concentrator 20 may execute Ethernet communication. An Ethernet communication speed may be in the range of 10 to 1 Gbps. The concentrator modem 21 and each electricity meter modem 12-1, 12-2, . . . , 12-N may execute power line communication, and the power line communication speed may be in the range of 0.1 to 200 Mbps. Also, each electricity meter modem 12-1, 12-2, . . . , 12-N and the metering/communication unit 11-1, 11-2, . . . , 11-N may execute infrared communication, and the infrared communication speed may be in the range of 9.6 to 19.2 kbps.

A communication speed of a system is converging onto the lowest speed of communication schemes used. Accordingly, the communication speed of the typical meter-reading method between the concentrator and the meters according to the related art is converging onto the speed of the infrared communication scheme. This may disable the use of the fast speed of the power line communication.

FIG. 2 is a configuration view of a parallel meter-reading method between a concentrator and electricity meters (meters) according to the related art.

The configuration of meters 11-1, 11-2, . . . , 11-N is equal to FIG. 1, and thus repetitive description will be omitted.

A plurality of meter-reading processors 32-1, 32-2, . . . , 32-N of a concentrator 30 may be connected in parallel to a concentrator modem 31. The concentrator modem 31 and a plurality of electricity meter modems 12-1, 12-2, . . . , 12-N may execute power line communication. Each electricity meter modem 12-1, 12-2, . . . , 12-N and each metering/communication unit 11-1, 11-2, . . . , 11-N may execute infrared communication. The concentrator 30 in the parallel meter-reading method overcomes the communication speed lowering problem caused in the typical meter-reading between the concentrator and the meters according to the related art using the plurality of meter-reading processors 32-1, 32-2, . . . , 32-N.

FIG. 3 is an exemplary view illustrating an occurrence of a collision between signals received by the concentrator, due to a hidden node in the parallel meter-reading method between the concentrator and the meters according to the related art.

As illustrated in FIG. 3, the concentrator 30 may be installed on a secondary winding in a pole transformer, and receive electric power of three phases (such as R, S and T phases). The pole transformer may transfer the three-phase electric power to each consumer. Each consumer may be provided with an electricity meter. The concentrator 30 may read metered data by sorting (in other words classifying or dividing) a plurality of electricity meters into a plurality of meter-reading groups.

For example, when a plurality of electricity meters are sorted into a plurality of meter-reading groups, without taking into account a power line distribution system, the concentrator 30 may sort the plurality of electricity meters receiving different phase electric power into one meter-reading group.

That is, electricity meters 33-1, 34-1 and 35-1 may be sorted into a first meter-reading group, electricity meters 33-2, 34-2 and 35-2 into a second meter-reading group and electricity meters 33-M, 34-M and 35-M into an M^{th} meter-reading group.

The parallel meter-reading uses a carrier sense multiple access/collision avoidance (CSMA/CA). Therefore, the concentrator modem (not shown) may execute power line communication with each electricity meter modem (not shown) of the electricity meters 33-1, 34-1 and 35-1 of the first meter-reading group 36-1.

However, the power line communication may not be executable among the electricity meter modems of the electricity meters 33-1, 34-1 and 35-1 belong to the first meter-reading group.

Accordingly, one of the plurality of electricity meters sorted into one meter-reading group may not be aware of information related to whether or not the other electricity meters communicate with the concentrator 30. Here, the electricity meters whose information is unknown are defined as hidden nodes.

When the plurality of electricity meters transmit signals to the concentrator 30 at the same time, the signals received by the concentrator 30 may cause collision therebetween or the signal receiving sequence may be turned. This may result in lowering power line communication efficiency between the concentrator 30 and the electricity meters.

A magnitude of a signal may be reduced as a distance becomes farther, and the signal may be more likely to be mixed with noise. Consequently, the second meter-reading group 36-2 rather than the first meter-reading group 36-1, and the M^{th} meter-reading group 36-3 rather than the meter-reading group 36-2 may be much affected by the hidden node.

### SUMMARY OF THE DISCLOSURE

Therefore, to obviate the drawbacks of the related art, an aspect of the present disclosure is to provide a method for avoiding a hidden node, which is generated due to a 3-phases power line structure, by way of sorting each meter-reading group based on each phase, in association with a parallel meter-reading method between a concentrator and electricity meters.

To achieve these and other advantages and in accordance with the purpose of this disclosure, as embodied and broadly described herein, there is provided a parallel meter-reading method between a concentrator and electricity meters, the method comprising:

a) determining by a concentrator modem each of three phases of electric power supplied from a concentrator to the electricity meters;

b) generating by the concentrator modem a reference signal synchronized with electric power determined for each phase;

c) generating by the concentrator modem a request signal synchronized with each of the three phases electric power determined for each phase and transmitting the generated request signal to an electricity meter modem;

d) receiving by the electricity meter modem the request signal;

e) determining by the electricity meter modem a phase of electric power supplied to the electricity meter according to the request signal;

f) generating by the electricity meter modem a response signal synchronized with the determined phase of electric power and transmitting the generated response signal to the concentrator modem; and

g) receiving by the concentrator modem the response signal of the electricity meter modem with respect to the request signal, and determining whether or not the response signal is synchronized with the reference signal to determine the phase of electric power supplied to the electricity meter.

In one aspect of the present disclosure, the step a) may be performed by the concentrator modem to determine phases of the three phases electric power, supplied by the concentrator, by using a zero-cross detector for each phase.

In one aspect of the present disclosure, the step e) may be performed by the concentrator modem to determine the phase of for electric power supplied to the electricity meter by using a zero-cross detector.

In one aspect of the present disclosure, the step g) may further comprise classifying by the concentrator the electricity meters sorted for each phase into one meter-reading group for each phase.

In one aspect of the present disclosure, the step g) may further comprise classifying by the concentrator the electricity meters sorted for each phase into a plurality of meter-reading groups for each phase.

In one aspect of the present disclosure, the step f) may further comprise receiving, by the electricity meter modem located within an one-hop range from the concentrator, a response signal of an electricity meter modem located outside the one-hop range, and transmitting the received response signal, together with its own response signal, to the concentrator modem.

Further scope of applicability of the present application will become more apparent from the detailed description given hereinafter. However, it should be understood that the detailed description and specific examples, while indicating preferred embodiments of the disclosure, are given by way of illustration only, since various changes and modifications within the spirit and scope of the disclosure will become apparent to those skilled in the art from the detailed description.

### BRIEF DESCRIPTION OF THE DRAWINGS

The accompanying drawings, which are included to provide a further understanding of the disclosure and are incorporated in and constitute a part of this disclosure, illustrate exemplary embodiments and together with the description serve to explain the principles of the disclosure.

In the drawings:

FIG. 1 is a configuration view illustrating a typical meter-reading method between a concentrator and electricity meters according to the related art;

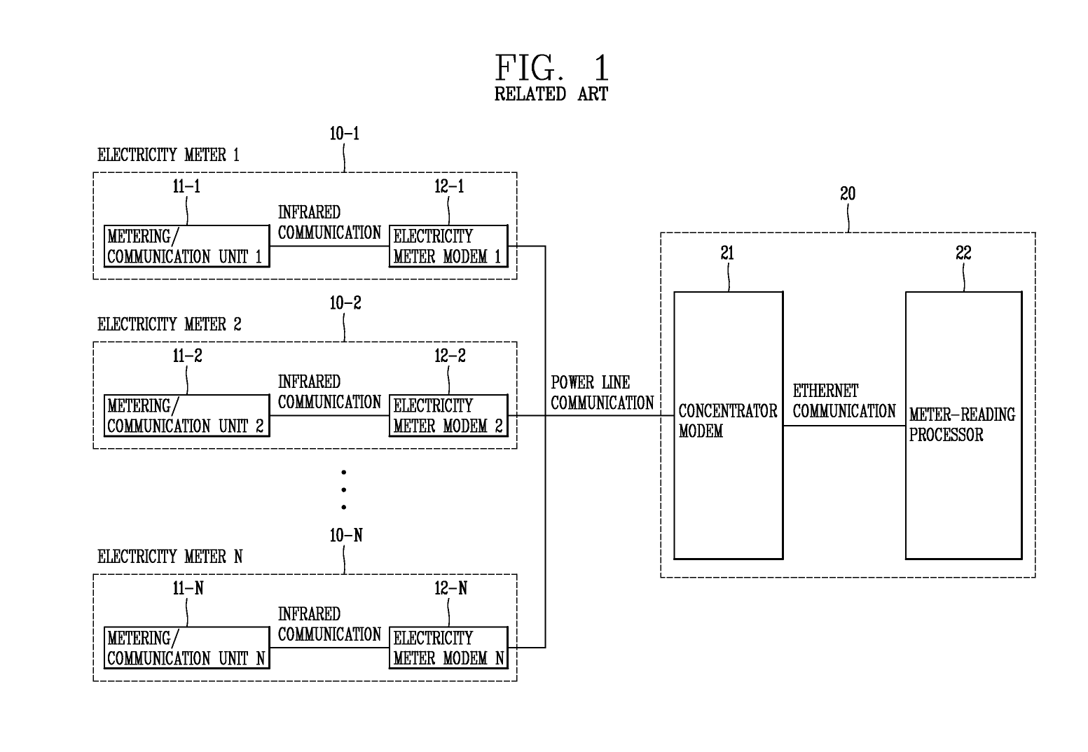

FIG. 2 is a configuration view illustrating a parallel meter-reading method between a concentrator and electricity meters according to the related art;

FIG. 3 is an exemplary view illustrating an occurrence of a collision between signals received by the concentrator, due to a hidden node in the parallel meter-reading method between the concentrator and the electricity meters according to the related art;

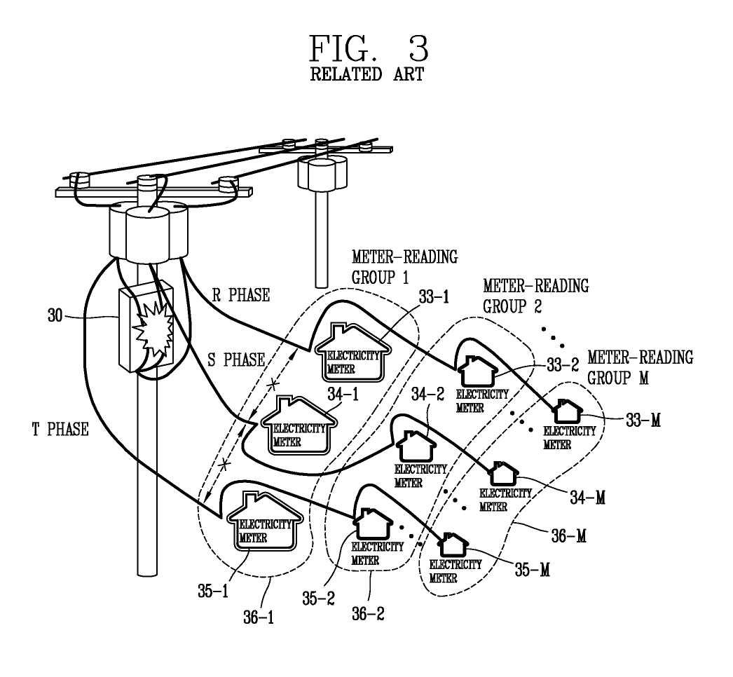

FIG. 4 is an exemplary embodiment illustrating a parallel meter-reading method between a concentrator and electricity meters to avoid a hidden node in accordance with the present invention;

FIG. 5 is a flowchart illustrating a parallel meter-reading method between a concentrator and electricity meters to avoid a hidden node in accordance with the present invention;

FIG. 6 is a view illustrating a detection principle of a zero-cross detector in accordance with the present invention; and

FIG. 7 is an exemplary view illustrating a method of detecting a phase of electric power supplied to an electricity meter in accordance with the present invention.

### DETAILED DESCRIPTION OF THE INVENTION

Description will now be given in detail of the exemplary embodiments, with reference to the accompanying drawings. The accompanying drawings are used to help easily understood the technical idea of the present invention and it should be understood that the idea of the present invention is not limited by the accompanying drawings. The idea of the present invention should be construed to extend to any alterations, equivalents and substitutes besides the accompanying drawings.

Furthermore, the terms including an ordinal number such as first, second, etc. can be used to describe various elements, but the elements should not be limited by those terms. The terms are used merely for the purpose to distinguish an element from the other element.

It will be understood that when an element is referred to as being “connected with” another element, the element can be directly connected with the other element or intervening elements may also be present. In contrast, when an element is referred to as being “directly connected with” another element, there are no intervening elements present.

It should be noted that technological terms used herein are merely used to describe a specific embodiment, but not to limit the present disclosure. Incidentally, unless clearly used otherwise, expressions in the singular number include a plural meaning. In this application, the terms “comprising” and “including” should not be construed to necessarily include all of the elements or steps disclosed herein, and should be construed not to include some of the elements or steps thereof, or should be construed to further include additional elements or steps.

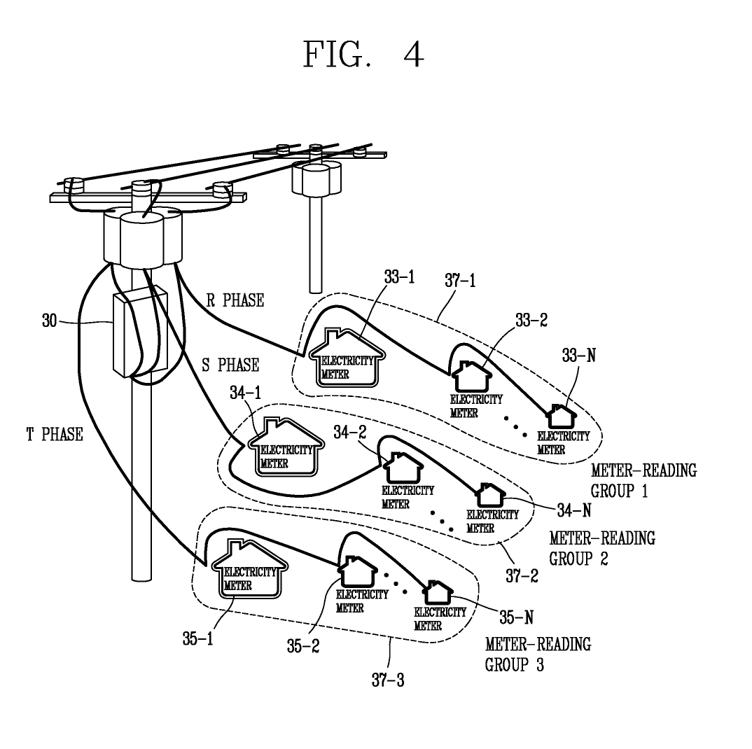

FIG. 4 is an exemplary embodiment illustrating a parallel meter-reading method between a concentrator and electricity meters to avoid a hidden node in accordance with the present disclosure.

As illustrated in FIG. 4, a concentrator 30 may sort a plurality of electricity meters for each phase of three-phases electric power (in other words three-phases alternating current electric power), namely, into R-phase electricity meters 33-1, 33-2, . . . , 33-N, S-phase electricity meters 34-1, 34-2, . . . , 34-N, and T-phase electricity meters 35-1, 35-2, . . . , 35-N.

The sorted electricity meters may be classified (in other words divided) into one meter-reading group according to each phase. That is, the sorted electricity meters may be classified into a first meter-reading group 37-1, a second meter-reading group 37-2, and a third meter-reading group 37-3 for each phase.

The parallel meter-reading method according to the present disclosure illustrates that the electricity meters are classified into one meter-reading group for each phase. However, the present disclosure may not be limited to this. The electricity meters may also be classified into a plurality of meter-reading groups for each phase.

Electricity meters receiving electric power of the same phase may be allowed for executing power line communication therebetween. Therefore, by the classification into the meter-reading groups 37-1, 37-2 and 37-3 for each phase, a hidden node which may be caused due to different phases of electric power supplied may be avoided, and collision between signals received by the concentrator 30 may also be avoided.

Hereinafter, description will be given in detail of a method for determining a phase of electric power supplied to each electricity meter to classify (in other words sort or divide) the meter-reading group for each phase.

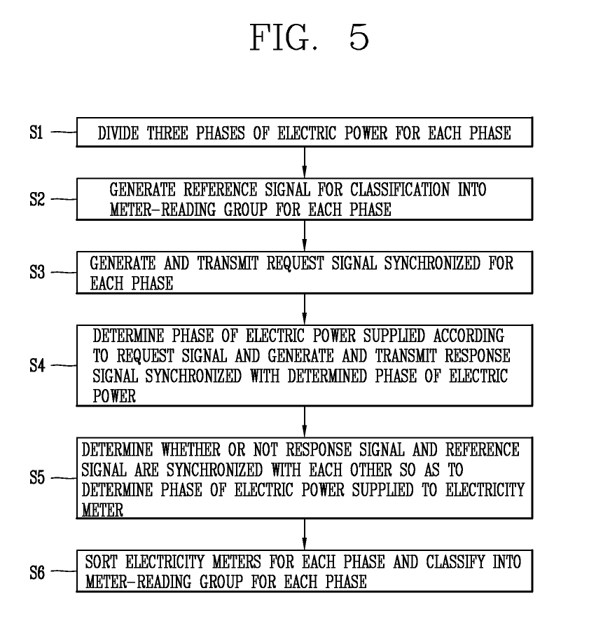

FIG. 5 is a flowchart illustrating a parallel meter-reading method between a concentrator and electricity meters to avoid a hidden node in accordance with the present disclosure.

The concentrator modem 31 may sort (classify) a phase (for example R-phase, S-phase, and T-phase) of three phases electric power supplied to electricity meters (S1), and generate a reference signal for classifying a meter-reading group for each phase (S2). The reference signal may be generated for each phase.

The concentrator modem 31 may generate a request signal synchronized with each phase-based electric power, and transmit the generated request signal to each electricity meter modem (S3). The request signal may be a signal for requesting information related to a phase of electric power supplied to the electricity meter. The concentrator modem 31 may transmit the request signal to a random electricity meter modem.

Each electricity meter modem may determine the phase of electric power supplied to the electricity meter, and generate a response signal synchronized with the determined electric power to transmit to the concentrator modem 31 (S4). The response signal may include information related to the phase of electric power supplied to the electricity meter.

The concentrator 30 may determine whether or not the response signal transmitted by the electricity meter modem is synchronized with the reference signal (S5). That is, the concentrator 30 may determine whether or not the response signal is synchronized with the reference signal generated for each phase, to determine the phase of electric power supplied to the electricity meter.

The concentrator 30 may sort the electricity meters for each phase and classify the sorted electricity meters into a meter-reading group according to each phase (S6).

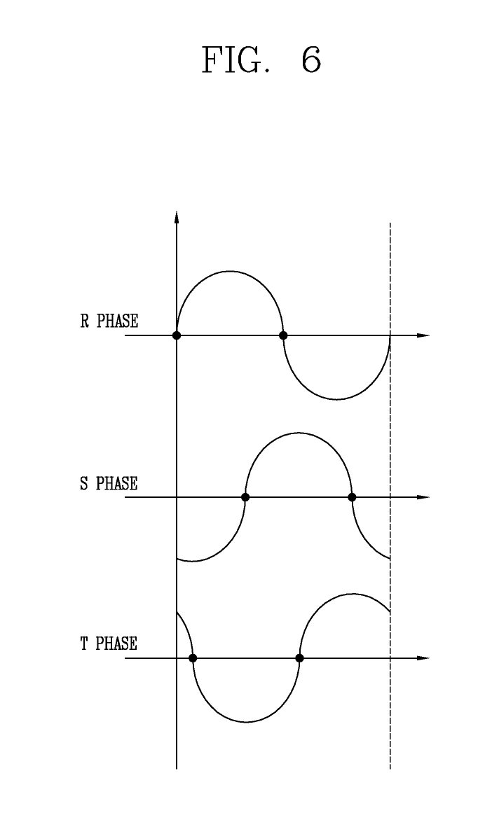

FIG. 6 is a view illustrating a detection principle of a zero-cross detector in accordance with the present invention.

As illustrated in FIG. 6, three phases electric power may include R-phase electric power, S-phase electric power and T-phase electric power, and each may have a form of sine wave. The sine wave may have a moment (in other words time point) that its size becomes 0(zero) per every cycle. This is referred to as a zero-cross point. That is, a zero-cross detector may search for a point where the size of the sine wave is 0(zero).

For example, if it is assumed that a case where an initial point (origin point) is the zero-cross point is R-phase electric power, there may be two zero-cross points found, having a phase difference of 120° based on the initial point where the size of the R-phase electric power becomes 0. Electric power flowing through one of the two zero-cross points may have the S-phase, and electric power flowing through the other may have the T-phase.

Therefore, the concentrator modem 31 may classify a phase of three-phases electric power supplied to the electricity meters into R-phase, S-phase and T-phase using the zero-cross detector.

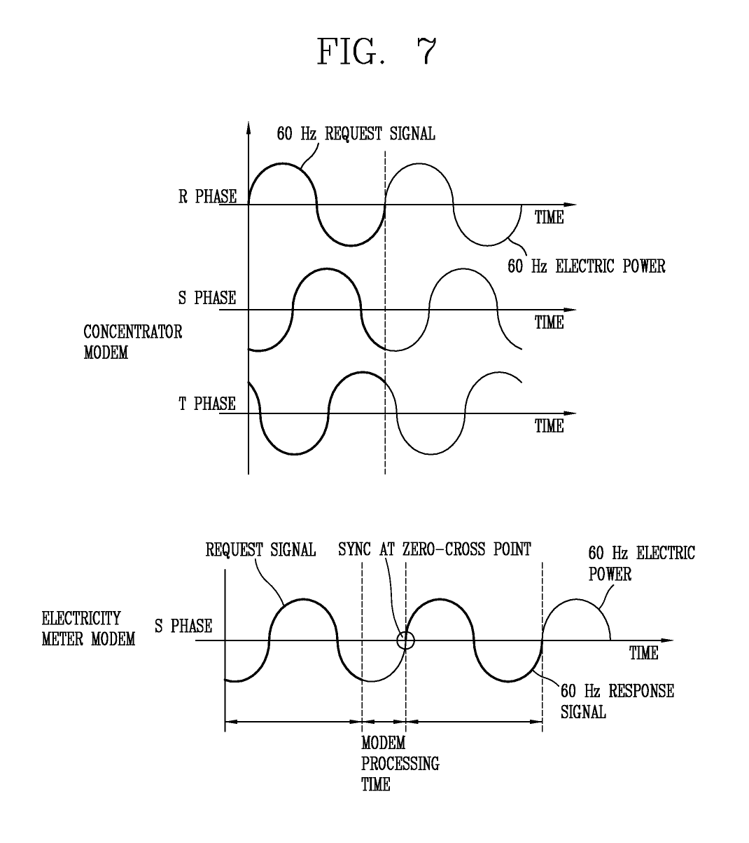

FIG. 7 is an exemplary view illustrating a method of detecting a phase of electric power supplied to an electricity meter in accordance with the present disclosure.

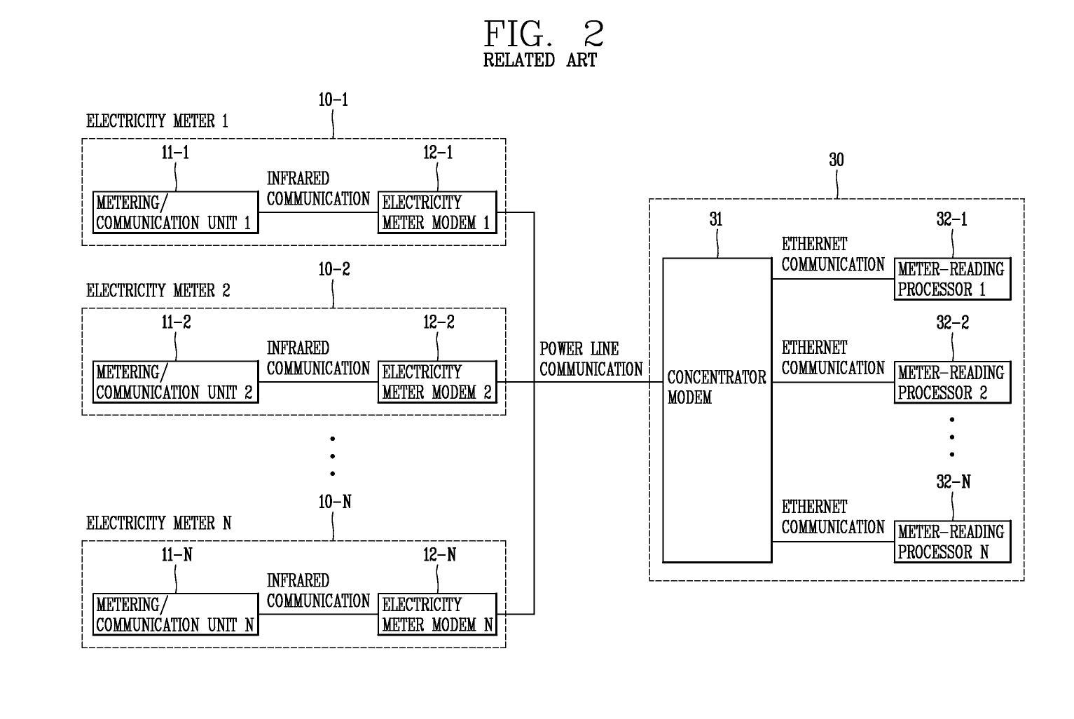

Referring to FIGS. 2, 4 and 7, the concentrator modem 31 may generate a request signal synchronized with each phase of three phases electric power, and transmit the request signal to each electricity meter.

The concentrator 30 may be allowed to transmit the request signal to a random electricity meter because of having a list of power line communication modems of all the electricity meters. The concentrator 30 may register (in other words record and save) the list of power line communication modems in an automatic or manual manner.

The request signal may be a signal for requesting information related to a phase of electric power supplied to an electricity meter, and preferably use a frequency of 60 Hz. This is because electric power supplied to a consumer generally uses a frequency of 60 Hz, and the request signal is able to be transmitted to the consumer by being synchronized with electric power when the frequency of the request signal is equal to the frequency of electric power supplied. Here, the frequency may not be limited to this, and it may be obvious that other frequencies can also be used.

Since a consumer receives single-phase electric power (in other words single-phase alternating current electric power), an electricity meter modem (not shown) may detect a zero-cross point of the single-phase electric power supplied by using a zero-cross detector.

The electricity meter modem may generate a response signal synchronized with the detected zero-cross point, and transmit the response signal to the concentrator modem 31. The response signal may include information related to a phase of electric power supplied to the meter.

A modem processing time denotes a time spent for detecting the zero-cross point.

The concentrator modem 31 may detect a zero-cross point of the response signal using the zero-cross detector. The concentrator modem 31 may determine whether the response signal is synchronized with a reference signal of R-phase, S-phase or T-phase based on the zero-cross point of the response signal.

That is, upon being synchronized with one of the three phases, the concentrator 30 may determine it as the phase of the electric power supplied to the electricity meter. This may allow the concentrator 30 to be aware of the phase of electric power supplied to the electricity meter.

When such processes are repeated, the phases of electric power supplied to all of the electricity meters may be determined. Accordingly, the concentrator 30 may classify the plurality of electricity meters sorted for each phase into a plurality of meter-reading groups matching each phase.

When the electricity meter modem and the concentrator modem 31 exceed a maximum distance (One-hop range) allowing for communication, the concentrator modem 31 may be unable to receive a response signal transmitted by the electricity meter modem, and the electricity meter modem may be unable to receive a request signal transmitted by the concentrator modem 31.

The electricity meter modem located within the one-hop range from the concentrator 30 may receive a response signal of an electricity meter modem located at a distance that the response signal is unable to be transmitted to the concentrator 30, and then transmit the received response signal to the concentrator modem. Consequently, the electricity meter modem may operate as a repeater.

The repeater may receive the response signal of the electricity meter modem located away from the one-hop range from the concentrator 30, and transmit a response signal synchronized with its own zero-cross point to the concentrator modem 30. Therefore, the repeater may transmit its own response signal and the response signal of the electricity meter modem located outside the one-hop range to the concentrator modem 31. This may allow the electricity meters to be sorted not only into one meter-reading group but also into a plurality of meter-reading groups for each phase.

The foregoing embodiments and advantages are merely exemplary and are not to be construed as limiting the present disclosure. The present teachings can be readily applied to other types of apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

As the present features may be embodied in several forms without departing from the characteristics thereof, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

What is claimed is:

1. A parallel meter-reading method between a concentrator and electricity meters, the method comprising:
a) determining by a concentrator modem each of three phases of electric power supplied from a concentrator to the electricity meters;
b) generating by the concentrator modem a reference signal synchronized with electric power determined for each phase;
c) generating by the concentrator modem a request signal synchronized with each of the three phases electric power determined for each phase and transmitting the generated request signal to an electricity meter modem;
d) receiving by the electricity meter modem the request signal;
e) determining by the electricity meter modem a phase of electric power supplied to the electricity meter according to the request signal;
f) generating by the electricity meter modem a response signal synchronized with the determined phase of electric power and transmitting the generated response signal to the concentrator modem; and
g) receiving by the concentrator modem the response signal of the electricity meter modem with respect to the request signal, and determining whether or not the response signal is synchronized with the reference signal to determine the phase of electric power supplied to the electricity meter.

2. The method of claim 1, wherein the step a) is performed by the concentrator modem to determine phases of the three phases electric power, supplied by the concentrator, by using a zero-cross detector for each phase.

3. The method of claim 1, wherein the step e) is performed by the concentrator modem to determine the phase of for electric power supplied to the electricity meter by using a zero-cross detector.

4. The method of claim 1, wherein the step g) further comprises classifying by the concentrator the electricity meters sorted for each phase into one meter-reading group for each phase.

5. The method of claim 1, wherein the step g) further comprises classifying by the concentrator the electricity meters sorted for each phase into a plurality of meter-reading groups for each phase.

6. The method of claim 1, wherein the step f) further comprises receiving, by the electricity meter modem located within an one-hop range from the concentrator, a response signal of an electricity meter modem located outside the one-hop range, and transmitting the received response signal, together with its own response signal, to the concentrator modem.
